(19) United States
(12) Patent Application Publication
(10) Pub. No.: US 2018/0327671 A1
(43) Pub. Date: Nov. 15, 2018

(54) FLAME RETARDANT LIQUID SOLUTION, POLYURETHANE FOAM-FORMING COMPOSITIONS, POLYURETHANE FOAM AND ARTICLES MADE THEREFROM

(71) Applicant: ICP-IP AMERICA INC., Tarrytown, NY (US)

(72) Inventors: Jeffrey STOWELL, Wingdale, NY (US); Barbara WILLIAMS, New York, NY (US); Kali SURYADEVARA, Saginaw Township, MI (US); Mark GELMONT, Haifa Israel (IL); Munjal PATEL, Lindenhurst, IL (US)

(21) Appl. No.: 15/776,502

(22) PCT Filed: Nov. 14, 2016
(86) PCT No.: PCT/US2016/061766

§ 371 Date: May 16, 2018

Related U.S. Application Data
(60) Provisional application No. 62/256,911, filed on Nov. 18, 2015.

(51) Int. Cl. C09K 21/12; C09K 21/08; C08G 18/42; C08G 18/46; C08G 18/50; C08G 18/18; C08G 18/22; C08G 18/16; C08J 9/12; C08J 9/14; C08J 9/00; C08K 5/136; C08K 5/1515; C08K 5/5333; C08K 5/5353; C08K 5/12

(52) U.S. Cl. CPC C09K 21/12; C08G 2101/00; C08G 18/4208; C08G 18/4669; C08G 18/5096; C08G 18/1833; C08G 18/18; C08G 18/227; C08G 18/163; C08J 9/125; C08J 9/146; C08J 9/0023; C08J 9/0038; C08K 5/136; C08K 5/1515; C08K 5/5333; C08K 5/5353; C08K 5/12; C09K 21/08

(57) ABSTRACT

There is provided herein a flame retardant liquid solution comprising a brominated flame retardant solute and a hydroxyl-functional phosphonate solvent of the general formula (I) described herein; and, wherein the solvent of the general formula (I) has a viscosity of less than 1,000 cps. In addition, there is provided a polyurethane foam-forming composition comprising a polyol, a catalyst and the flame retardant liquid solution, or alternatively, polyurethane foam-forming composition comprising an a catalyst and the flame retardant liquid solution, wherein the hydroxyl-functional phosphonate solvent of the general formula (I) functions as a hydroxyl-containing component and/or a flame retardant in the polyurethane foam-forming composition, as well as articles made from either of the polyurethane foam-forming compositions.

This application claims priority to provisional U.S. Patent Application No. 62/256,911 filed on Nov. 18, 2015.

### FIELD OF THE INVENTION

The present invention relates to a flame retardant liquid solution, polyurethane foam-forming compositions containing the same, polyurethane foam formed from the polyurethane foam-forming compositions, and polyurethane foam articles made therefrom.

### DESCRIPTION OF RELATED ART

Polyurethanes are materials that are suitable for a large number of different applications in the industrial and private sectors. However, their use presents problems whenever it is involved in areas where there is a risk of fire. To modify their fire behavior, flame-retarding agents are usually added to these polyurethane materials.

Solid flame retardant additives such as melamine, ammonium polyphosphate and many brominated flame retardant additives are highly effective flame-retarding agents for polyurethane foam. Unfortunately, such solid flame retardant additives have various processing problems associated with their use. In addition, the solid nature of such flame retardant additives increases the viscosity of the flame retardant foam system to the point that the overall viscosity is unmanageable.

There has been some use of additive viscosity modifiers but the use of such modifiers has the potential to plasticize the foam and/or migrate out of the foam over time. Alternatively the use of reactive alcohol/glycol solvents increases the flammability of the resulting foam. Therefore, it would be desirable to provide a means of avoiding these quality and processing difficulties.

### BRIEF SUMMARY OF THE INVENTION

There is provided herein a flame retardant liquid solution that has improved processing and foam product characteristics. The foam made there from has an advantageous lower viscosity to polyurethane foam applications.

Specifically, there is provided herein a flame retardant liquid solution comprising, or consisting essentially of, or consisting of a brominated flame retardant solute and a hydroxyl-functional phosphonate solvent of the general formula (I):

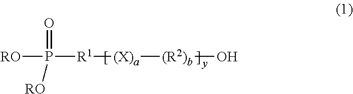

where each R is independently the same or different, linear or branched alkyl group of from 1 to about 8 carbon atoms, linear or branched alkenyl group of from 2 to about 10 carbon atoms, cycloalkenyl group of from about 5 to about 10 carbon atoms, and cycloalkyl group of from about 5 to about 10 carbon atoms, and wherein each R group can be optionally joined to each other in order to form a substituted or unsubstituted ring of from 4 to about 7 carbon atoms;

R¹ is a linear or branched divalent alkylene group containing from 1 to about 6 carbon atoms;

R² is a linear or branched divalent alkylene group containing from 1 to about 20 carbon atoms; and,

X is a heteroatom group; and,

the subscript y is an integer of from 0 to 10, and the subscripts a and b are each independently zero or 1, and, provided that when y≥1 then a+b≥1; and,

wherein the solvent of the general formula (I) has a viscosity of less than 1.000 cps.

As used herein “consisting essentially of” in terms of the flame retardant liquid solution contains the hydroxyl-functional phosphonate solvent, the brominated flame retardant solute and optionally, one or more of other solvent, catalyst, other flame retardants, polyol, blowing agent, water, antioxidant, ultraviolet absorber, lubricant, and pigment.

As used herein “consisting of” in terms of the flame retardant liquid solution contains the hydroxyl-functional phosphonate solvent and the brominated flame retardant solute.

### BRIEF DESCRIPTION OF THE DRAWINGS

FIG. 1 is a graph of cone calorimetry performance of Foam Samples 1, 2, and 3 shown in the examples.

FIG. 2 is a graph showing the Heat Release Rate curves in the first five minutes of the cone calorimeter run at 40 kW/m² in ambient air of samples 1, 2 and 3 shown in the examples.

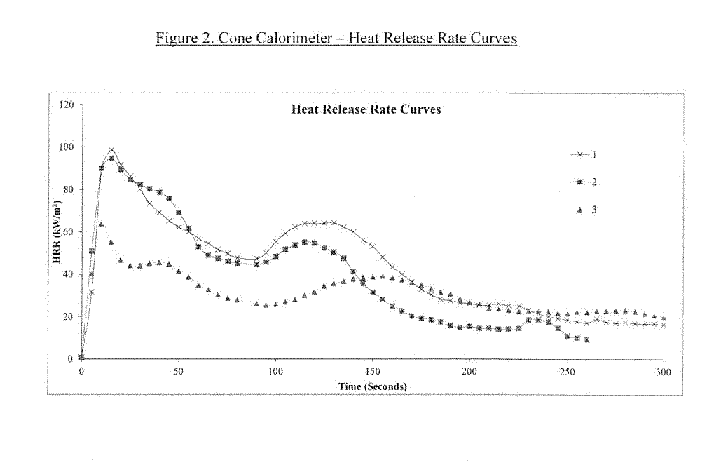

FIG. 3 is a graph of DIN 4102 performance of Foam Samples 1, 2 and 3 shown in the examples.

### DETAILED DESCRIPTION OF THE INVENTION

The inventors herein have unexpectedly discovered that hydroxyl-functional phosphonate of the general formula (I), as described herein, can serve as a low-viscosity, non-flammable reactive phosphorous-based solvent for brominated flame retardants, especially highly viscous or solid brominated flame retardants.

It will be understood herein that all ranges herein include all subranges there between and also any combination of endpoints of said ranges.

It will be understood herein that the expression linear or branched divalent alkylene group comprises a saturated linear or branched alkyl group which has sufficient hydrogen atoms removed therefrom to allow the alkyl group to be divalent.

It will be understood herein that the expression linear or branched divalent alkenylene group comprises an alkenyl group which has sufficient hydrogen atoms removed therefrom to allow the alkyl group to be divalent.

Unless indicated otherwise, all weight percentages herein are based on the total weight of the reaction components.

All temperatures herein are room temperature unless indicated otherwise.

All viscosity measurements recited herein are conducted at 25 degrees Celsius and using a Brookfield capillary viscometer. All pressures indicated herein are 1 atmosphere at sea level and at 25 degrees Celsius unless indicated otherwise.

The term “liquid” as used herein is understood to be a substance with a viscosity of less than 10,000 cps, more specifically less than 7,500 cps, and most specifically less than 5,000 cps and at most 10,000 cps, more specifically at most 12,500 cps and most specifically at most 15,000 cps measured at 25 degrees Celsius.

In one embodiment herein the term “solution” as used herein is understood to be a homogenous mixture of one phase, i.e., a mixture wherein there is no precipitate visible to the unaided eye. In another embodiment herein the term “solution” can be defined to be a mixture having the amounts of solvent and/or solute described herein.

The expression “flame retardant liquid solution” can be used interchangeably with “flame retardant composition”.

In one more specific embodiment herein the general formula (I) as described above can be such where each R is independently the same or different, linear or branched alkyl group of from 1 to about 8 carbon atoms, more specifically 1 to about 6 carbon atoms, even more specifically from 1 to about 4 carbon atoms, such as the non-limiting examples of methyl and ethyl; linear or branched alkenyl group of from 2 to about 10 carbon atoms, more specifically from 2 to about 8 carbon atoms, even more specifically from 3 to about 6 carbon atoms; cycloalkenyl group of from about 5 to about 10 carbon atoms, more specifically from about 6 to about 10 carbon atoms, and most specifically from 6 to about 8 carbon atoms; and, cycloalkyl group of from about 5 to about 10 carbon atoms, more specifically from about 6 to about 10 carbon atoms, and most specifically from 6 to about 8 carbon atoms; and wherein each of the above described R groups can be optionally joined to each other in order to form a ring;

R¹ is a linear or branched divalent alkylene group containing from 1 to about 6 carbon atoms, more specifically from 1 to about 4 carbon atoms, and even more specifically from 1 to about 2 carbon atoms, such as the non-limiting examples of divalent methylene and ethylene;

X is a heteroatom group, more specifically. X is selected from the group consisting of an oxygen atom, a sulfur atom, an —N(R⁴)— group, a selenium atom, a —O—P(OR⁴)(O)— group, a sulfoxide group, a sulfone group, wherein each R⁴ is independently a substituted or unsubstituted hydrocarbyl group of from about 1 to about 8 carbon atoms, more specifically wherein R⁴ is a hydroxyl-terminated alkylene group of from 1 to about 4 carbon atoms such as the non-limiting example of —CH₂CH₂OH;

R² is a linear or branched divalent alkylene group containing from 1 to about 20 carbon atoms, more specifically from 1 to about 16 carbon atoms, more specifically from 1 to about 12 carbon atoms and most specifically from 1 to about 8 carbon atoms, such as the non-limiting examples of methylene, ethylene, and propylene; and,

the subscript y is an integer of from 0 to 10 and the subscripts a and b are each independently zero or 1, and provided that when y≥1 then a+b≥1, and

wherein the hydroxyl-functional phosphonate solvent of the general formula (I) has a viscosity of less than 1,000 cps, more specifically less than 750 cps and most specifically less than 500 cps.

In one embodiment, each R is a linear alkyl group of from 1 to about 4 carbon atoms and the subscripts a and b are each zero. In a different embodiment, each R group is a linear alkyl group of from 1 to about 4 carbon atoms both of which are joined to each other in order to form a ring and the subscripts a and b are each zero.

In one embodiment, each R is a linear alkyl group of from 1 to about 4 carbon atoms and the subscripts a and b are each one. In a different embodiment, each R group is a linear alkyl group of from 1 to about 4 carbon atoms both of which are joined to each other in order to form a ring and the subscripts a and b are each one.

In one non-limiting embodiment, the hydroxyl-functional phosphonate of general formula (I) is one or more of the general formula:

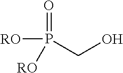

and/or, the general formula:

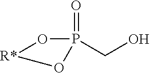

wherein each R is as described herein, and R* is a linear or branched divalent alkylene group of from 2 to about 10 carbon atoms, preferably from 3 to about 8 carbon atoms, linear or branched divalent alkenylene group of from 2 to about 10 carbon atoms, and more preferably from about 3 to about 8 carbon atoms, divalent cycloalkenyl group of from about 5 to about 10 carbon atoms, and more preferably from about 5 to about 8 carbon atoms, and divalent cycloalkyl group of from about 5 to about 10 carbon atoms, and, more preferably from about 5 to about 8 carbon atoms. R* preferably is a linear or branched divalent alkylene group containing from 3 to about 8 carbon atoms such as, for example, propylene, 2-methylpropylene, neopentylene or 2-butyl-2-ethylpropylene.

In one embodiment, the general formula (I) is such wherein R¹ is a linear divalent alkylene group of from 1 to about 4 carbon atoms, the subscript a is one, X is an oxygen atom, and each R is a linear alkyl group of from 1 to about 4 carbon atoms, both of which are joined to each other in order to form a ring of the moiety (II):

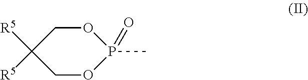

wherein each R⁵ is independently a linear or branched alkyl group of from 1 to about 6 carbon atoms, and wherein the dashed line represents a bond to the R¹ group of formula (I).

In a further embodiment, the general formula (I) is such that R¹ is a linear divalent alkylene group of from 1 to about 4 carbon atoms, the subscript a is one, X is an oxygen atom, and each R is a linear alkyl group of from 1 to about 4 carbon atoms, both of which are joined to each other in order to form a ring of the moiety (II) as described above, and preferably wherein R¹ in general formula (I) is a —CH₂— or —CH₂CH₂— group, the subscript b is one, and R² is a —CH₂CH₂— group.

In one other embodiment the general formula (I) is such that R¹ is a linear divalent alkylene group of from 1 to about 4 carbon atoms, the subscript a is one, y≥1, X is an oxygen atom, and each R is a linear alkyl group of from 1 to about 4 carbon atoms, and preferably, wherein R¹ in general formula (I) is a —CH₂— or —CH₂CH₂— group, the subscript b is one and R² is —CH₂CH₂—.

Some non-limiting examples of hydroxyl-functional phosphonates can include dimethyl hydroxymethylphosphonate, diethyl hydroxymethylphosphonate, diethyl hydroxyethylphosphonate, diethyl hydroxypropylphosphonate, dipropyl hydroxymethylphosphonate, diisopropyl hydroxymethylphosphonate, methyl ethyl hydroxymethylphosphonate, methyl propyl hydroxymethylphosphonate, methyl isopropyl hydroxymethylphosphonate, ethyl propyl hydroxymethylphosphonate, ethyl isopropyl hydroxymethylphosphonate, propyl isopropyl hydroxymethylphosphonate, dibutyl hydroxymethylphosphonate, dioctyl hydroxymethylphosphonate, propyl pentyl hydroxymethylphosphonate, dicyclohexyl hydroxymethylphosphonate, 1,3,2-dioxaphosphorinane, 5-methyl-2-(hydroxymethyl), 2-oxide; 1,3,2-dioxaphosphorinane, 5,5-dimethyl-2-(hydroxymethyl), 2-oxide; 1,3,2-dioxaphosphorinane, 5-ethyl-6-propyl-2-(hydroxymethyl), 2-oxide; 1,3,2-dioxaphosphorinane, 5,5-dimethyl-6-isopropyl-2-(hydroxymethyl), 2-oxide; 1,3,2-dioxaphosphorinane, 5-butyl-5-ethyl-2-(hydroxymethyl), 2-oxide, diethyl bis(hydroxyethyl) aminomethyl phosphonate and combinations thereof.

As the brominated flame retardant to be used according to the present invention, those ordinarily employed in this field can be used with no limitations. Among them, popularly employed are flame retardants such as brominated bisphenol A or brominated bisphenol S derivatives, brominated bisphenol A carbonate oligomer, brominated bisphenol A epoxy resin, end-capped brominated bisphenol A epoxy resin, aliphatic brominated alcohols and glycols, tribromoneopentyl alcohol, dibromoneopentyl glycol, brominated phthalates and tetrabromophthalate diols.

As the brominated bisphenol A or brominated bisphenol S and their derivatives, compounds having 1 to 8 bromine atoms bonded to the benzene ring of the bisphenol A residue or bisphenol S residue can be mentioned. Examples thereof include monobromobisphenol A, dibromobisphenol A, tribromobisphenol A, tetrabromobisphenol A, pentabromobisphenol A, hexabromobisphenol A, octabromobisphenol A, tetrabromobisphenol A bis(2-hydroxyethyl ether), tetrabromobisphenol A bis(2-bromoethyl ether), tetrabromobisphenol A bis(1,2-dibromoethyl ether), tetrabromobisphenol A bis(propyl ether), tetrabromobisphenol A bis(3-bromopropyl ether), tetrabromobisphenol A bis(2,3-dibromopropyl ether), monobromobisphenol S, dibromobisphenol S, tribromobisphenol S, tetrabromobisphenol S, pentabromobisphenol S, hexabromobisphenol S, octabromobisphenol S, tetrabromobisphenol S bis(2-hydroxyethyl ether), tetrabromobisphenol S bis(2-bromoethyl ether), tetrabromobisphenol S bis(1,2-dibromoethyl ether), tetrabromobisphenol S bis(propyl ether), tetrabromobisphenol S bis(3-bromopropyl ether), tetrabromobisphenol S bis(2,3-dibromopropyl ether) and the like.

As commercially available brominated bisphenol A or brominated bisphenol S can be mentioned, for example, “FR-1524”, ex Bromokem (Far East) Ltd., “Great Lakes BA-50”. “Great Lakes BA-50P”, “Great Lakes BA-59”. “Great Lakes BA-59P” and “Great Lakes PE-68”, ex Great Lakes Chemical Corporation. “Saytex RB-100” ex Albemarle Corporation. “Fire Guard 2000”. “Fire Guard 3000”, “Fire Guard 3100” and “Fire Guard 3600” ex Teijin Chemicals Ltd., “Nonnen PR-2” ex Marubishi Oil Chemical Co., Ltd., and the like.

The brominated bisphenol A carbonate oligomer is a polymer of the group represented by the following formula:

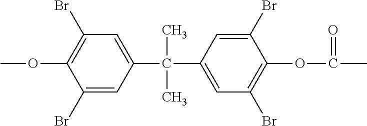 [SMILES: COc1c(Br)cc(C(C)(C)c2cc(Br)c(OC(C)=O)c(Br)c2)cc1Br]

and the term “oligomer” as used herein means that having a polymerization degree (n) of 1 to 10.

A flame retardant represented by the following formula:

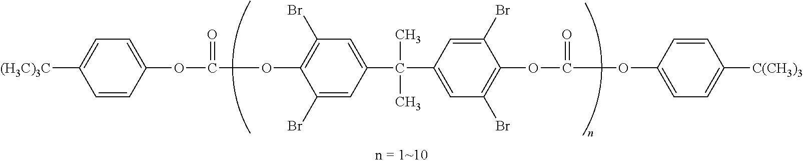

can be mentioned by way of example. Examples of the commercially available flame retardant of the above-described formula can include “Fire Guard 7000” and “Fire Guard 7500” ex Teijin Chemicals Ltd.

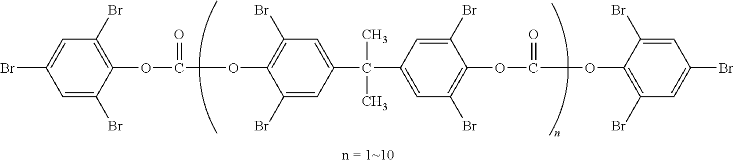

Examples of the commercially available flame retardant represented by the above-described formula can include “Great Lakes BC-52” and “Great Lakes BC-58” ex Great Lakes Chemical Corporation, and the like. As examples of the brominated bisphenol A epoxy resin can be mentioned those compounds represented by the following formula:

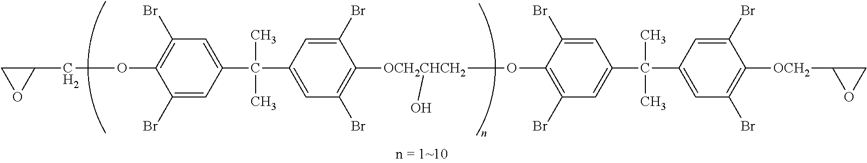

As the commercially available flame retardant represented by the above-described formula, there are various products depending on the polymerization degree (n). Examples thereof can include “F-2016”, “F-2100”, “F-2400” and “F-2400H” ex Israel Chemicals (Far East) Ltd., “PRATHERM EP-16”, “PRATHERM EP-30”, “PRATHERM EP-100” and “PRATHERM EP-500” ex Dainippon Ink & Chemicals, Incorporated, and “SR-T1000”, “SR-T2000”, “SR-T5000” and “SR-T20000” ex Sakamoto Yakuhin Kogyo Co., Ltd., and the like.

As the brominated bisphenol A epoxy resin can be mentioned those compounds of the above-described formula wherein the epoxy group at each of both ends has been blocked with a blocking agent, and those compounds of the above-described formula wherein the epoxy group at one end has been blocked with a blocking agent. Although no particular limitations are imposed on the blocking agent insofar as it is a compound permitting the ring-opening addition of the epoxy group, examples thereof can include phenols, alcohols, carboxylic acids, amines, isocyanates and the like, each containing a bromine atom. Among them, brominated phenols are preferred for improving flame retarding effects. Examples thereof can include dibromophenol, tribromophenol, pentabromophenol, dibromoethylphenol, dibromopropylphenol, dibromobutylphenol, dibromocresol and the like.

Examples of the above-described polymer having epoxy groups, at both ends thereof, blocked with a blocking agent, as flame retardants, can include flame retardants represented by the following formulae:

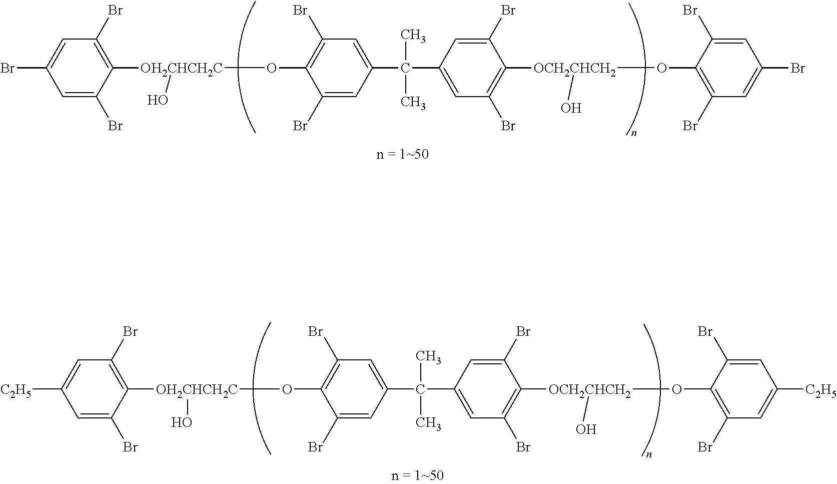

Examples of the commercially available flame retardant of the above-described formula can include “F-3014”, “F-3020” and “F-3100” ex Israel Chemicals (Far East) Ltd., “PRATHERM EC-14”. “PRATHERM EC-20” and “PRATHERM EC-30” ex Dainippon Ink & Chemicals, Incorporated, “TB-60” and “TB-62” ex Tohto Chemical Co., Ltd., “SR-T3040” and “SR-T7040” ex Sakamoto Yakuhin Kogyo Co., Ltd., and the like.

Examples of the polymer having an epoxy group, at one end thereof, blocked with a blocking agent, as flame retardants, can include flame retardants represented by the following formulas:

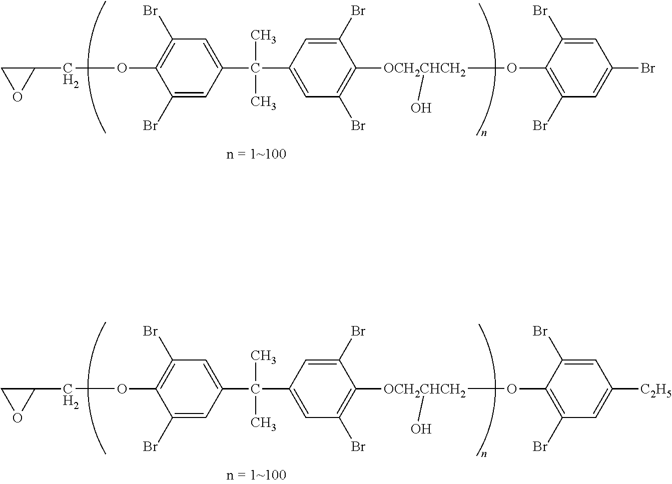

Examples of the commercially available flame retardant of the above-described formula can include “PRATHERM EPC-15F” ex Dainippon Ink & Chemicals, Incorporated, “E5354” ex Yuka Shell Epoxy Kabushiki Kaisha, and the like.

Brominated phthalic acids are compounds having 1 to 4 bromine atoms bonded to phthalic anhydride. Examples thereof can include monobromophthalic anhydride, dibromophthalic anhydride, tribromophthalic anhydride, tetrabromophthalic anhydride, and the like.

In one embodiment herein the brominated flame retardant solute can be any of the brominated flame retardants described in U.S. Patent Application Publication Nos. 2010/0113630 and 2014/0303271 the contents of both of which are incorporated by reference herein in their entireties.

In one embodiment herein the brominated flame retardant solute is selected from the group consisting of brominated bisphenol A compounds, brominated bisphenol S compounds, brominated bisphenol F compounds, brominated bisphenol A carbonate oligomers, brominated bisphenol A epoxy resins, end-capped brominated bisphenol A epoxy resin, aliphatic brominated alcohols and glycols, tribromoneopentyl alcohol, dibromoneopentyl glycol, brominated phthalates and tetrabromophthalate diols brominated phosphates, brominated phenolsbrominated phthalic acids, and combinations thereof.

In another embodiment herein the brominated flame retardant solute is selected from the group consisting of tribromoneopentyl alcohol; (4,4′-(1-methylethylidene) bis[2,6-dibromophenol]polymer with (chloromethyl)oxirane; 2,4,6-tribromophenol; tetrabromophthalate diol; tetrabromobisphenol A; tetrabromobisphenol A bis(2,3-dibromopropyl ether); tris(tribromoneopentyl)phosphate; brominated polyacrylate; brominated epoxy polymers; end capped brominated epoxy polymers; phenoxy-terminated carbonate oligomers; tetrabromobisphenol S bis(2,3-dibromopropyl ether); 2-ethylhexyl tetrabromophthalate ester; and, combinations thereof.

The amount of the brominated flame retardant to be used according to the present invention varies depending on the relationship between the extent of the flame retardation required of polyurethane foam and physical properties. However, the brominated flame retardant is usually used in an amount of 1 to 50 parts by weight based on 100 parts by weight of a polyurethane foam. In an amount less than 1 part by weight, desired flame retardancy cannot be imparted. Amounts exceeding 50 parts by weight bring about sufficient flame retardancy but may impair the physical properties of the molded or formed product of the resulting foam. Amounts outside the above-described range are therefore not preferred. From the viewpoint of keeping good balance between the flame retardancy and physical properties, the amount practically falls within a range of 3 to 30 parts. Depending on the using purpose, two or more brominated flame retardants can be used in combination.

Effective solvation or suspension of the brominated flame retardant solute in the hydroxyl-functional phosphonate solvent of the general formula (I) can vary greatly depending on the specific hydroxyl-functional phosphonate solvent and the amount of bromine flame retardant solute employed in the flame retardant liquid solution described herein. Preferably, effective solvation/suspension can comprise sufficient solvent to effect solvation/suspension of from at least 95 weight percent of the bromine flame retardant solute, based on the total weight of bromine flame retardant solute, to an amount of solvent that is up to about 100 percent more solvent than is necessary for the complete dissolution/suspension of the total bromine flame retardant solute being employed, said latter percent being based upon the total amount of solvent necessary to completely solvate/suspend the total amount of bromine flame retardant solute being employed. More specifically, the amount of solvent present will be sufficient to solvate/suspend from about 99 weight percent of the bromine flame retardant solute, up to about 25 percent more solvent than is necessary to completely solvate/suspend the total bromine flame retardant solute being employed. In one embodiment, solvent is used in at least the amount necessary to completely solvate and/or suspend the amount of bromine flame retardant solute being used at the reaction temperature being employed. In one embodiment the amount of brominated flame retardant solute is such that is necessary to achieve a value within any of the ranges of solvation/suspension described herein.

More specifically, the amount of brominated flame retardant can be present in the flame retardant liquid solution in a weight percent of from about 5 to about 95 weight percent, even more specifically from about 10 to about 90 weight percent. Likewise the amount of hydroxyl-functional phosphonate that can be present in the flame retardant liquid solution in a weight percent of from about 5 to about 95 weight percent, even more specifically from about 10 to about 90 weight percent.

In one specific embodiment, the solvent is a hydroxyalkylphosphonate solvent, more preferably a diethyl hydroxymethylphosphonate and/or a diethyl hydroxyethylphosphonate, or any of the hydroxyalkylphosphonates described herein.

In another embodiment herein, the flame retardant liquid solution can further comprise other secondary solvent, i.e., other than hydroxyl-functional phosphonate of formula (I) as described herein. Some non-limiting examples of these secondary solvents can comprise methanol, ethanol, propanol, isopropanol, butanol, ethylene glycol, diethylene glycol and combinations thereof.

In one embodiment, the flame retardant liquid solution herein is in the absence of other solvent.

The secondary solvent, if present, can be present in the solvating ranges described above but preferably about 5 to about 30 weight percent, more preferably from about 1 to about 20 weight percent and most preferably, from about 1 to about 10 weight percent, said weight percent being based on the total weight of the flame retardant liquid solution.

The flame retardant liquid solution herein can be advantageously utilized in polyurethane foam-forming compositions as a flame-retardant for the polyurethane foam formed therefrom and/or as a polyol component in the polyurethane-foam forming composition. Such polyurethane foam-forming compositions, and those described herein, made using the liquid flame retardant solution, can be reacted to form polyurethane foams, which foams can be utilized in the construction, insulation and formation of various articles such as furniture, bedding, automotive seat cushions, panel, and pour-in-place and spray foam insulation.

Preferably there is provided herein a polyurethane foam-forming composition comprising a polyol, an isocyanate, a catalyst and the flame retardant liquid described herein. In one embodiment herein, the polyurethane foam-forming composition described herein can be a Part B of a polyurethane formulation which when combined with an isocyanate component, which is the Part A of the polyurethane formulation, the reaction of Part A and Part B forms a polyurethane foam under polyurethane foam-forming conditions which are known to those skilled in the art. In one embodiment herein the polyurethane foam forming composition and/or polyurethane foam formulation can be for a spray foam and in further embodiments can be for a polyurethane flexible foam.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

### EXAMPLES

### Application Testing of Bromine FR/Solvent Blend Systems

The following work was completed to show examples wherein a reactive solvent was used as a solvent/carrier for highly viscous or solid brominated flame retardants (FR's) for the sole purpose of creating flame resistant polyurethane foams. The target foams were prepared in a series of 4 inch thick rigid spray foam panels for predictive small-scale fire tests including cone calorimeter and DIN 4102 tests, as well as large scale E-84 Steiner Tunnel testing with a nominal 2 lb foam density on gypsum board. Different FR's were included in the study at various loading levels with the end goal of achieving Class-I formulations. Two panels 2′×16′ and 2′×8′ were prepared for each of the three different formulations for E84 tunnel testing. Smaller box samples were also sprayed for the lab scale flammability tests.

Cone calorimeter tests were conducted at 40 kW/m² radiant heat flux for all the samples by running triplicate runs on each sample measuring 4″×4″×1″ size. The samples were wrapped in heavy duty aluminum foil and then placed onto the sample holder enclosed by a retainer frame to avoid any edge effects from the burning specimen. The average reaction-to-fire properties including the rate of heat release was measured according to the ISO 5660-1 standard and the smoke production according to the ASTM E1354 standard. Combustion of all the sample specimens was deemed complete when no visible flames were observed over the sample surface or the heat release rate values reached below 5 kW/m² and therefore all calculated parameters (heat release and smoke) were determined until the end-of-test criteria was reached.

DIN 4102 test is a standard flammability test in Germany for combustible products and is widely used to test materials for building construction. The DIN 4102 is a small scale test with two modes, either with the ignition source impinging the surface of the sample or the edge of the sample. The flame height is 20 mm and is held for duration of 15 seconds. If the flame height is less than 15 cm the sample is classified as a B2 rating, which typically satisfies European market needs.

### Formulation Information:

| Formulation Ingredient | 1 | 2 | 3 |
|---|---|---|---|
| HT 5100 aromatic polyester polyol available | 48.0 | 48.0 | 48.0 |
| from Terate | | | |
| MX425 is a 530 MW Mannich base polyether | 25.0 | 25.0 | 25.0 |
| polyol tetrol based on manich base, propylene | | | |
| oxide and 20% ethylene oxide cap available | | | |
| from Carpenter Co. | | | |
| DC193 is dimethyl methyl(propyl(polyethylene | 1.0 | 1.0 | 1.0 |
| oxide))hydroxy)siloxane, trimethylsiloxy- | | | |
| terminated available from Dow Corning | | | |
| Dabco BL-11 catalyst 70% bis(2-Dimethyl- | 1.0 | 1.0 | 1.0 |
| aminoethyl) ether diluted with 30% dipropylene | | | |
| glycol available from Dabco. | | | |
| Polycat 77 tertiary amine catalyst available | 1.0 | 1.0 | 1.0 |
| from Air Products. | | | |
| BiCat 8210 bismuth carboxylates catalyst | 0.6 | 0.6 | 0.6 |
| mixture available from Sheperd. | | | |
| Water | 2.5 | 2.5 | 2.5 |
| HFC-245 1,1,1,3,3-pentafluoropropane | 10.0 | 10.0 | 10.0 |
| available from Honeywell | | | |
| Sample 1 - 30/30/40 ratio of FR-513, F-3014, | 10.0 | | |
| E06-16 | | | |
| Sample 2 - 30/30/40 ratio of FR-513, F-3014, | | 10.0 | |
| Fyrol 6 | | | |
| Sample 3 - 60/40 ratio of PHT4-diol, E06-16 | | | 15.0 |
| Total (# of parts) | 99.1 | 99.1 | 104.1 |
| Specific Gravity | 1.23 | 1.23 | 1.22 |
| NCO index | 98.5 | 97.0 | 100.5 |
| % Bromine | 2.01 | 2.01 | 1.98 |
| % Phosphorus | 0.36 | 0.24 | 0.52 |

Underlined Examples 1 and 3 in the above formulation table are the panels that achieved Class I and borderline ClassI/Class II in the E84 tunnel testing at 4.0″ inch thickness.

FR-513: tribromoneopentyl alcohol (available from ICL-IP America)
F-3014: tribromophenol end-capped tetrabromobisphenol-A epoxy (available from ICL-IP America)
E06-16: a hydroxyalkylphosphonate flame retardant (available from ICL-IP America)
Fyrol 6: diethyl N,N bis(2-hydroxyethyl) aminomethylphosphonate (available from ICL-IP America product)
PHT4-diol: tetrabromophthalate diol (available from Great Lakes Solutions)

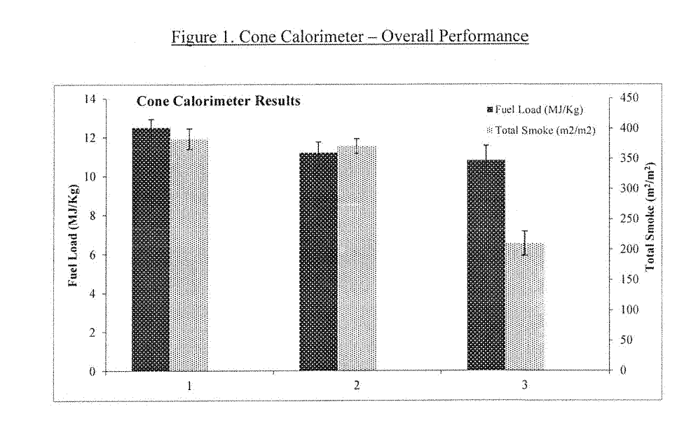

Cone calorimeter was used as a screening tool to study the reaction-to-fire behavior of the SPF samples by evaluating heat (peak heat release rate [pHRR], fuel load [total heat release/initial mass], and average heat release rate) and smoke (total smoke). Smoke and fuel load of the foam samples are shown below in FIG. 1 with error bars. During a typical flame retardant (FR) lab evaluation process, the FR loading in a spray polyurethane foam (SPF) formulation is targeted in such a way that the fuel load and total smoke values from the cone calorimeter are as close as possible to a reference SPF sample known to have an E84 Class-I rating. The calculated % bromine and % phosphorus content in the foams based on the formulations are shown in FIG. 1.

All the samples displayed an initial increase in HRR until an efficient char layer formed. However, all the samples exhibited a second peak that was a result of cracking/splitting during the burning of the sample specimen. Sample #3 had the lowest pHRR and as a result the area under the HRR curve (Total heat release) for the sample was the lowest amongst all the SPF panels tested in the cone calorimeter and had the lowest fuel load as reported in FIG. 1.

The following Table corresponds to FIG. 1:

| | | | |
|---|---|---|---|
| FR loading | 10 | 10 | 15 |
| % Bromine | 2.01 | 2.01 | 1.98 |
| % Phosphorus | 0.36 | 0.24 | 0.52 |

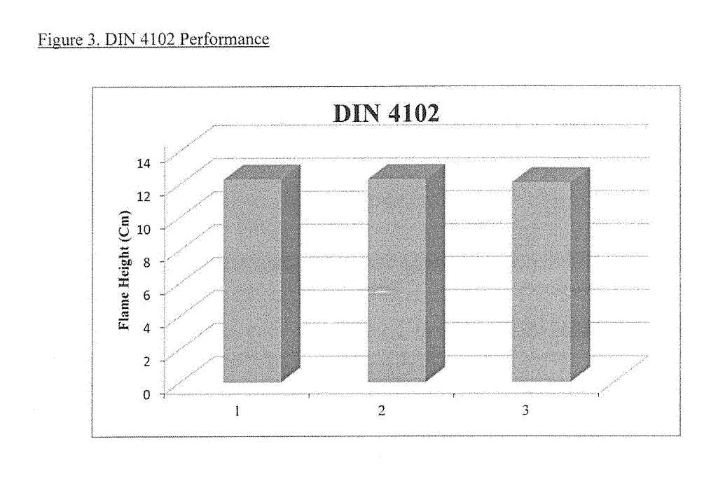

The DIN 4102 test is a standard fire test method used by the European PU market. This test was conducted on the three SPF foam samples in-house. Based on the testing criteria, all the flame retardants yielded a solid B2 rating (<15 cm flame height) as shown in FIG. 3. It is typical for foam product manufacturers to produce their products with a DIN 4102 flame height ranging from 12-13 cm to avoid any risk in supplying product compositions with borderline performance characteristics to their customers.

E84 Steiner tunnel tests were performed on the spray foam panels at four inch thickness with varying FR loading as reported in FIG. 1. The E84 test results are shown in Table 1.

TABLE 1
E-84 tunnel results for 4.0″ inch closed-
cell spray foam panels at 2.0 pcf (lb/ft³) density

| | | Flame | Smoke | |
|---|---|---|---|---|
| Flame | Loading | Spread | Index | Classification/ |
| Retardant | (parts) | (actual) | (actual) | comments |
| Sample 1 | 10 | 28 | 442 | Class II - Borderline |
| | | | | flame spread to Class I |
| Sample 2 | 10 | 118 | 350 | Failed |
| Sample 3 | 15 | 22.5 | 350 | Class I |

SPF Sample 1 achieved a borderline rating on flame spread towards Class-I and a smoke index of ≤450. Sample 2 was low in smoke index but half way during the test procedure, portions of char residue fell from the spray panels resulting in a very high flame spread number. SPF Sample 3 achieved a good Class-I rating at four inch thickness. In addition, SPF panels made using reactive solvents yielded panels with good physical and thermal properties.

In addition to showing the fire performance of these brominated FR/reactive solvent carrier systems for rigid SPF application systems, extraction studies were performed to ensure the reactive solvents used were incorporated in the PU foam matrix and were therefore non-leachable after foam preparation.

The following extraction method was used to show solvent/carrier reactivity in the foam matrix. The finished foam samples were cut into small pieces and weighed into a polyseal vial. Methylene chloride was accurately pipetted into the vial, and the solution was shaken vigorously using an automatic shaker. The sample and solvent were allowed to sit overnight. The foam is then crushed in the solvent several times using the round end of a plastic disposable pipette and the solvent is then drained into a beaker. The solvent extracts then undergo a filtration step to remove any foam particulates in the solution. An accurate volume of clear solvent extract is pipetted into a clean vial and then evaporated to dryness using a light N₂ stream. The residue after drying is dissolved in internal standard solution and analyzed by gas chromatography to identify any of the reactive solvents/carriers used to deliver the brominated FR products into the foam formulations.

The extraction results are shown below:

| Sample | Amount of Reactive Solvent Used | Reactive Solvent In Extract |
|---|---|---|
| # | (wt %) | (wt %) |
| 1 | 2.02 | ND |
| 2 | 2.02 | ND |
| 3 | 2.89 | ND |

ND—Non-detectable (<0.02%)

Based on the extraction results obtained, the reactive solvents used as carriers for the brominated FR products mentioned above were fully incorporated into the foam matrix and no longer present in their original form in the polyurethane foam.

1. A flame retardant liquid solution comprising a brominated flame retardant solute and a hydroxyl-functional phosphonate solvent of the general formula (I): 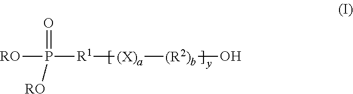
where each R is independently the same or different, linear or branched alkyl group of from 1 to about 8 carbon atoms, linear or branched alkenyl group of from 2 to about 10 carbon atoms, cycloalkenyl group of from about 5 to about 10 carbon atoms, and cycloalkyl group of from about 5 to about 10 carbon atoms, and wherein each R group can be optionally joined to each other in order to form a substituted or unsubstituted ring of from 4 to about 7 carbon atoms;
R¹ is a linear or branched divalent alkylene group containing from 1 to about 6 carbon atoms;
R² is a linear or branched divalent alkylene group containing from 1 to about 20 carbon atoms; and,
X is a heteroatom group; and,
the subscript y is an integer of from 0 to 10, and the subscripts a and b are each independently zero or 1, and,
provided that when y≥1 then a+b≥1; and,
wherein the solvent of the general formula (I) has a viscosity of less than 1,000 cps.

2. The flame retardant liquid solution of claim 1 wherein each R is a linear alkyl group of from 1 to about 4 carbon atoms and the subscripts a, b, and y are each zero.

3. The flame retardant liquid solution of claim 1 wherein each R group is a linear alkyl group of from 1 to about 4 carbon atoms both of which are joined to each other in order to form a ring of from about 4 to about 7 carbon atoms, and the subscripts a, b, and y are each zero.

4. The flame retardant liquid solution of claim 1 wherein each R group is a linear alkyl group of from 1 to about 4 carbon atoms, and the subscripts a and b are each one.

5. The flame retardant liquid solution of claim 1 wherein each R group is a linear alkyl group of from 1 to about 4 carbon atoms both of which are joined to each other in order to form a ring of from about 4 to about 7 carbon atoms, and the subscripts a and b are each one.

6. The flame retardant liquid solution of claim 1 wherein X is selected from the group consisting of an oxygen atom, a sulfur atom, an —N(R⁴)— group, a selenium atom, a —O—P(OR⁴)(O)— group, a sulfoxide group, a sulfone group, wherein R⁴ is a substituted or unsubstituted hydrocarbyl group of from 1 to about 4 carbon atoms.

7. The flame retardant liquid solution of claim 6 wherein a is one, X is —N(CH₂CH₂OH)—, b is one, and R² is —CH₂CH—.

8. The flame retardant liquid solution of claim 1 wherein R¹ is a linear divalent alkylene group of from 1 to about 4 carbon atoms, the subscript a is one, X is an oxygen atom, and each R is a linear alkyl group of from 1 to about 4 carbon atoms, both of which are joined to each other in order to form a ring of the moiety (II): 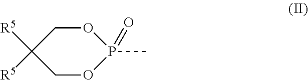
wherein each R⁵ is independently a linear or branched alkyl group of from 1 to about 6 carbon atoms, and the dashed line represents a bond to the R¹ group of formula (I).

9. The flame retardant liquid solution of claim 8 wherein R¹ is a —CH₂— group, the subscript b is one, and R² is —CH₂CH₂—.

10. The flame retardant liquid solution of claim 8 wherein R¹ is a —CH₂CH₂— group, the subscript b is one, and R² is —CH₂CH₂—.

11. The flame retardant liquid solution of claim 1 wherein R¹ is a linear divalent alkylene group of from 1 to about 4 carbon atoms, the subscript a is one, X is an oxygen atom, and each R is a linear alkyl group of from 1 to about 4 carbon atoms.

12. The flame retardant liquid solution of claim 11 wherein R¹ is —CH₂—, the subscript b is one, R² is —CH₂CH₂—.

13. The flame retardant liquid solution of claim 11 wherein R¹ is a —CH₂CH₂— group, the subscript b is one, R² is —CH₂CH₂—.

14. The flame retardant liquid solution of claim 1 wherein hydroxyl-functional phosphonate solvent of the general formula (I) is selected from the group consisting of dimethyl hydroxymethylphosphonate, diethyl hydroxymethylphosphonate, diethyl hydroxyethylphosphonate, diethyl hydroxypropylphosphonate, dipropyl hydroxymethylphosphonate, diisopropyl hydroxymethylphosphonate, methyl ethyl hydroxymethylphosphonate, methyl propyl hydroxymethylphosphonate, methyl isopropyl hydroxymethylphosphonate, ethyl propyl hydroxymethylphosphonate, ethyl isopropyl hydroxymethylphosphonate, propyl isopropyl hydroxymethylphosphonate, dibutyl hydroxymethylphosphonate, dioctyl hydroxymethylphosphonate, propyl pentyl hydroxymethylphosphonate, dicyclohexyl hydroxymethylphosphonate,1,3,2-dioxaphosphorinane, 5-methyl-2-(hydroxymethyl), 2-oxide; 1,3,2-dioxaphosphorinane, 5,5-dimethyl-2-(hydroxymethyl), 2-oxide; 1,3,2-dioxaphosphorinane, 5-ethyl-6-propyl-2-(hydroxymethyl), 2-oxide; 1,3,2-dioxaphosphorinane, 5,5-dimethyl-6-isopropyl-2-(hydroxymethyl), 2-oxide; 1,3,2-dioxaphosphorinane, 5-butyl-5-ethyl-2-(hydroxymethyl), 2-oxide, diethyl bis(hydroxyethyl) aminomethyl phosphonate and combinations thereof.

15. The flame retardant liquid solution of claim 1 wherein the brominated flame retardant solute is selected from the group consisting of brominated bisphenol A compounds, brominated bisphenol S compounds, brominated bisphenol F compounds, brominated bisphenol A carbonate oligomers, brominated bisphenol A epoxy resins, end-capped brominated bisphenol A epoxy resin, aliphatic brominated alcohols and glycols, tribromoneopentyl alcohol, dibromoneopentyl glycol, brominated phthalates and tetrabromophthalate diols, brominated phosphates, brominated phthalic acids, and combinations thereof.

16. The flame retardant liquid solution of claim 1 wherein the brominated flame retardant solute is selected from the group consisting of tribromoneopentyl alcohol; (4,4′-(1-methylethylidene) bis[2,6-dibromophenol]polymer with (chloromethyl)oxirane; 2,4,6-tribromophenol; tetrabromophthalate diol; tetrabromobisphenol A; tetrabromobisphenol A bis(2,3-dibromopropyl ether); tris(tribromoneopentyl)phosphate; brominated polyacrylate; brominated epoxy polymers; end capped brominated epoxy polymers; phenoxy-terminated carbonate oligomers; tetrabromobisphenol S bis(2,3-dibromopropyl ether); 2-ethylhexyl tetrabromophthalate ester; and, combinations thereof.

17. The flame retardant liquid solution of claim 1 wherein the hydroxyl-functional phosphonate solvent of the general formula (I) is at least one of diethyl hydroxymethylphosphonate and diethyl N,N bis(2-hydroxyethyl) aminomethylphosphonate; and, the brominated flame retardant solute is at least one of tribromoneopentyl alcohol and tribromophenol end-capped brominated bisphenol A epoxy resin.

18. The flame retardant liquid solution of claim 17 wherein the hydroxyl-functional phosphonate solvent of the general formula (I) is diethyl hydroxymethylphosphonate.

19. The flame retardant liquid solution of claim 17 wherein the hydroxyl-functional phosphonate solvent of the general formula (I) is diethyl N,N bis(2-hydroxyethyl) aminomethylphosphonate.

20. The flame retardant liquid solution of claim 1 wherein the brominated flame retardant solute is present in a weight percent of from about 5 weight percent to about 95 weight percent.

21. A polyurethane foam-forming composition comprising a polyol, a catalyst and the flame retardant liquid solution of claim 1.

22. A polyurethane foam-forming composition comprising a catalyst and the flame retardant liquid solution of claim 1, wherein the hydroxyl-functional phosphonate solvent of the general formula (I) functions as a hydroxyl-containing solvent and/or a flame retardant in the polyurethane foam-forming composition.

23. A polyurethane foam made by reacting the polyurethane foam-forming composition of claim 21.

24. A polyurethane foam made by reacting the polyurethane foam-forming composition of claim 22.

25. An article made from the polyurethane foam of claim 23.

26. An article made from the polyurethane foam of claim 24.

27. The article of claim 25 wherein the article is selected from furniture, bedding, automotive seat cushions, panels, and pour-in-place and spray foam insulation.

28. The article of claim 26 wherein the article is selected from furniture, bedding, automotive seat cushions, panels, and pour-in-place and spray foam insulation.
